(19) United States
(12) Patent Application Publication
(10) Pub. No.: US 2018/0076917 A1
(43) Pub. Date: Mar. 15, 2018

(54) Short PUCCH In NR Networks

(71) Applicant: MediaTek Inc., Hsinchu City (TW)

(72) Inventors: Jiaxian Pan, Hsinchu City (TW); Xiu-Sheng Li, Taipei City (TW); Pei-Kai Liao, Nantou County (TW)

(21) Appl. No.: 15/704,012

(22) Filed: Sep. 14, 2017

Related U.S. Application Data
(60) Provisional application No. 62/394,271, filed on Sep. 14, 2016.

(51) Int. Cl. H04J 13/00; H04J 13/14; H04B 7/06; H04L 5/00

(52) U.S. Cl. CPC H04J 13/0062; H04J 13/14; H04L 1/1671; H04L 5/0053; H04B 7/0639

(57) ABSTRACT

Concepts and examples pertaining to short physical uplink control channel (PUCCH) in New Radio (NR) networks are described. A processor of a user equipment (UE) configures a short PUCCH comprising one or two orthogonal frequency-division multiplexing (OFDM) symbols. In configuring the short PUCCH, the processor selects a sequence from a plurality of different sequences each of which representative of a respective uplink control information (UCI). The selected sequence is transmitted by the processor in the short PUCCH to a node of a wireless communication network.

### CROSS REFERENCE TO RELATED PATENT APPLICATION(S)

The present disclosure claims the priority benefit of U.S. Provisional Patent Application No. 62/394,271, filed 14 Sep. 2016, the content of which is incorporated by reference in its entirety.

### TECHNICAL FIELD

The present disclosure is generally related to wireless communications and, more particularly, to combined coding design for short physical uplink control channel (PUCCH) in New Radio (NR) networks.

### BACKGROUND

Unless otherwise indicated herein, approaches described in this section are not prior art to the claims listed below and are not admitted as prior art by inclusion in this section.

In legacy Long-Term Evolution (LTE) wireless communication networks, the PUCCH has long duration of fourteen orthogonal frequency-division multiplexing (OFDM) symbols. This implies that latency can be at least fourteen OFDM symbols long. In NR wireless communication networks, short PUCCHs of one-symbol length and two-symbol length are adopted, along with the option of long PUCCH. As the duration of PUCCH is reduced from fourteen OFDM symbols to one or two OFDM symbols, latency is also reduced. Moreover, there are few uplink OFDM symbols in self-contained subframes, and self-contained subframes do not have enough OFDM symbols to support fourteen-symbol PUCCH.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In view of the benefits associated with short PUCCH, the present disclosure proposes schemes and concepts that provide various one-symbol PUCCH formats to realize short PUCCH in NR networks. The proposed schemes and concepts also provide a PUCCH format with multiple transmitting antennas. Additionally, the proposed schemes and concepts provide a two-symbol PUCCH format.

In one aspect, a method may involve a processor of a UE configuring a short PUCCH comprising one or two OFDM symbols. In configuring the short PUCCH, the method may involve the processor determining uplink control information (UCI) to be transmitted to a node of a wireless communication network, with the UCI being in one of a plurality of UCI states. In configuring the short PUCCH, the method may also involve the processor selecting a sequence from a plurality of different sequences each of which representative of a respective one of the plurality of UCI states. The method may further involve the processor transmitting the selected sequence in the short PUCCH to the node without a reference signal (RS).

In one aspect, a method may involve a processor of a UE configuring a short PUCCH comprising one or two OFDM symbols. In configuring the short PUCCH, the method may involve the processor generating a reference signal (RS) using a first sequence and generating uplink control information (UCI) using a modulation of a second sequence, with the UCI being in one of a plurality of UCI states. In configuring the short PUCCH, the method may also involve the processor performing either of: (1) selecting a sequence from a plurality of different sequences each of which representative of a respective one of the plurality of UCI states; or (2) selecting a modulation scheme from a plurality of different modulation schemes each of which representative of a respective one of the plurality of UCI states. Moreover, the method may involve the processor transmitting, using frequency division multiplexing (FDM), the selected sequence or the UCI with the selected modulation scheme in the short PUCCH with the RS.

In one aspect, a method may involve a processor of a UE configuring a short PUCCH comprising one or two OFDM symbols. In configuring the short PUCCH, the method may involve the processor generating a reference signal (RS) using a first sequence and generating uplink control information (UCI) using a modulation of a second sequence, with the UCI being in one of a plurality of UCI states. In configuring the short PUCCH, the method may also involve the processor performing either of: (1) selecting a sequence from a plurality of different sequences each of which representative of a respective one of the plurality of UCI states; or (2) selecting a modulation scheme from a plurality of different modulation schemes each of which representative of a respective one of the plurality of UCI states. Moreover, the method may involve the processor transmitting, using code division multiplexing (CDM), the selected sequence or the UCI with the selected modulation scheme in the short PUCCH with the RS.

It is noteworthy that, although description provided herein may be in the context of certain radio access technologies, networks and network topologies such as LTE, LTE-Advanced, LTE-Advanced Pro, 5^{th} Generation (5G), New Radio (NR) and Internet-of-Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example design and an example scenario in accordance with an implementation of the present disclosure.

FIG. 2 is a diagram of an example design as well as example scenarios in accordance with an implementation of the present disclosure.

FIG. 3 is a diagram of an example design and an example scenario in accordance with an implementation of the present disclosure.

FIG. 4 is a diagram of an example design and an example scenario in accordance with an implementation of the present disclosure.

FIG. 5 is a diagram of an example design and an example scenario in accordance with an implementation of the present disclosure.

FIG. 6 is a diagram of example scenarios in accordance with an implementation of the present disclosure.

FIG. 7 is a block diagram of an example system in accordance with an implementation of the present disclosure.

FIG. 8 is a flowchart of an example process in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

In general, the goal of a short PUCCH is to transmit uplink control information (UCI), which can include acknowledgements (ACK), negative acknowledgements (NACK) and scheduling requests (SR). The ACK, NACK and SR may be transmitted simultaneously or, alternatively, transmitted separately. Accordingly, the UCI may include ACK/NACK only, SR only, or ACK/NACK and SR. The ACK/NACK and SR may determine modulated symbol(s), base sequence(s), cyclic shift(s), and the resource block(s) (RB) in which the PUCCH is transmitted.

### One-Symbol PUCCH Formats

Under the proposed schemes in accordance with the present disclosure, a first format of the proposed one-symbol PUCCH formats is herein referred as sequence selection without reference signal (RS). In this PUCCH format, the UCI may determine the sequence in which to transmit without transmitting the RS. Moreover, the UCI may determine the following information: base sequence Y; cyclic shift α, and RB M, in which the PUCCH is transmitted.

In accordance with the present disclosure, a cyclic shift sequence may be generated according to α as follows:

$$d = ( \begin{matrix}exp ( - j 2 π α \frac{0}{{N}_{SC}^{RB}} ) \\ exp ( - j 2 π α \frac{1}{{N}_{SC}^{RB}} ) \\ ⋮ \\ exp ( - j 2 π α \frac{{N}_{SC}^{RB} - 1}{{N}_{SC}^{RB}} )\end{matrix} )$$

Here, N_{SC}^{RB} denotes the number of subcarriers in a RB.

The transmitting signal in a RB may be expressed as follows:

x=Y·⊙d

Here, Y·εC^{N}^{_{SC}}^{^{RB}} is a base sequence, and ⊙ means elementwise product. The transmitting signal x may then be put in all RBs in a RB set M,.

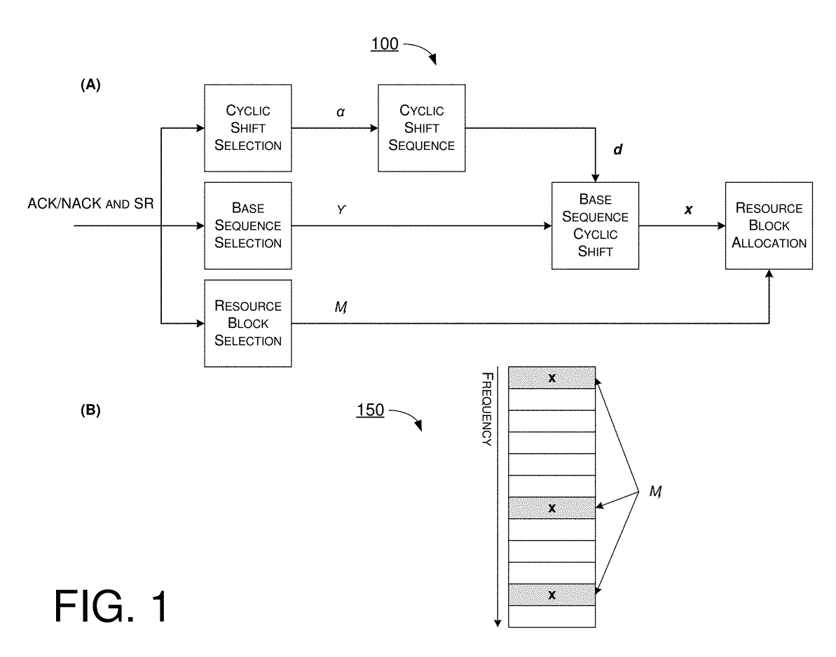

FIG. 1 illustrates an example design 100 and an example scenario 150 in accordance with an implementation of the present disclosure. Part (A) of FIG. 1 shows example design 100, and part (B) of FIG. 1 shows example scenario 150 of how the transmitting signal x may be put in all RBs in a RB set M,.

Referring to FIG. 1, in example design 100, information of ACK/NACK and SR may be taken as input for cyclic shift selection (to provide α), base sequence selectin (to provide Y) and RB selection (to provide M,). Using a as input for cyclic shift sequence, the result d, along with Y; is used as input for base sequence cyclic shift to provide the transmitting signal x. The transmitting signal x may then be put in RB set M, with RB allocation as shown in example scenario 150.

Under the proposed schemes, the base sequence Y· may be independent of UCI and may be configured by a base station (e.g., eNB, gNB or transmit-and-receive point (TRP)). The cyclic shift α may be determined by ACK/NACK, where α₀ may be configured by the base station.

In case of two-bit ACK/NACK, the cyclic shift α may be expressed as follows:

$$α = \{ \begin{matrix}{α}_{0} & if ACK / NACK = ( 0 , 0 ) \\ {α}_{0} + \frac{{N}_{SC}^{RB}}{4} & if ACK / NACK = ( 0 , 1 ) \\ {α}_{0} + \frac{2 {N}_{SC}^{RB}}{4} & if ACK / NACK = ( 1 , 0 ) \\ {α}_{0} + \frac{3 {N}_{SC}^{RB}}{4} & if ACK / NACK = ( 1 , 1 ) \end{matrix}$$

Alternatively, for two-bit ACK/NACK, the cyclic shift α may be expressed as follows:

$$α = \{ \begin{matrix}{α}_{0} & if ACK / NACK = ( 0 , 0 ) \\ {α}_{0} + 1 & if ACK / NACK = ( 0 , 1 ) \\ {α}_{0} + 2 & if ACK / NACK = ( 1 , 0 ) \\ {α}_{0} + 3 & if ACK / NACK = ( 1 , 1 )\end{matrix}$$

In case of one-bit ACK/NACK, the cyclic shift α may be expressed as follows:

$$α = \{ \begin{matrix}{α}_{0} & if ACK / NACK = ( 0 ) \\ {α}_{0} + \frac{{N}_{SC}^{RB}}{2} & if ACK / NACK = ( 1 ) \end{matrix}$$

Alternatively, for one-bit ACK/NACK, the cyclic shift α may be expressed as follows:

$$α = \{ \begin{matrix}{α}_{0} & if ACK / NACK = ( 0 ) \\ {α}_{0} + 1 & if ACK / NACK = ( 1 ) \end{matrix}$$

The RB set M,={n_{RB}} may be determined as follows:

$${M}_{1} = \{ \begin{matrix}\{ {n}_{RB} \} & if SR = 0 \\ \{ {n}_{RB} \} + 1 & if SR = 1\end{matrix}$$

Here, n_{RB} may be configured by the base station.

Under the proposed schemes, the base sequence Y· may be independent of UCI and may be configured by a base station.

In case of two-bit ACK/NACK, the cyclic shift α may be expressed as follows:

$${Y}^{′} = \{ \begin{matrix}{Y}_{0}^{′} & if ACK / NACK = ( 0 , 0 ) \\ {Y}_{1}^{′} & if ACK / NACK = ( 0 , 1 ) \\ {Y}_{2}^{′} & if ACK / NACK = ( 1 , 0 ) \\ {Y}_{3}^{′} & if ACK / NACK = ( 1 , 1 )\end{matrix}$$

Here, Y·₀, Y·₁, Y·₂ and Y·₃ may be configured by a base station.

In case of one-bit ACK/NACK, the cyclic shift α may be expressed as follows:

$${Y}^{′} = \{ \begin{matrix}{Y}_{0}^{′} & if ACK / NACK = ( 0 ) \\ {Y}_{0}^{′} & if ACK / NACK = ( 1 ) \end{matrix}$$

The cyclic shift α may be independent of UCI, and may be configured by the base station. The RB set M,={n_{RB}} may be determined as follows:

$${M}_{1} = \{ \begin{matrix}\{ {n}_{RB} \} & if SR = 0 \\ \{ {n}_{RB} \} + 1 & if SR = 1\end{matrix}$$

Here, n_{RB} may be configured by the base station.

Under the proposed schemes, the portion of UCI indicating or otherwise representing the ACK/NACK information and/or SR information may be in one of multiple states, depending on the actual bits indicating/representing the ACK/NACK information. For example, for two-bit ACK/NACK, the portion of UCI indicating or otherwise representing the ACK/NACK information may be in one of four states corresponding to the four possibilities of ACK/NACK=(0, 0), (0, 1), (1, 0) or (1, 1). As another example, for one-bit ACK/NACK, the portion of UCI indicating or otherwise representing the ACK/NACK information may be in one of two states corresponding to the two possibilities of ACK/NACK=(0) or (1). Similarly, the portion of UCI indicating or otherwise representing SR information may be in one of two states corresponding to the two possibilities of SR=0 or 1.

Under the proposed schemes, each of the multiple states of UCI (e.g., the portion of UCI indicating or otherwise representing the ACK/NACK information or SR information) may be represented by a corresponding sequence of multiple sequences that are different from each other. When transmitting UCI in the short PUCCH, the sequence corresponding to the given state of UCI may be transmitted in lieu of the actual UCI information. Thus, a sequence corresponding to the given state of UCI may be selected from the different sequences for transmission of UCI in the short PUCCH in accordance with the present disclosure. In selecting the sequence from the different sequences, a base sequence may be generated, and then a respective cyclic shift may be performed on the base sequence to generate each sequence of the plurality of different sequences such that different cyclic shifts are used to generate the plurality of different sequences. Alternatively, in selecting the sequence from the different sequences, multiple base sequences may be generated, and a same cyclic shift may be performed on each of the plurality of base sequences to generate a respective sequence of the plurality of different sequences. Alternatively or additionally, in selecting the sequence from the different sequences, a respective peak-to-average-power-ratio (PAPR) of each sequence of the plurality of different sequences may be determined. Then, one of the different sequences having the respective PAPR lower than a first threshold (e.g., a low threshold) and one or more cross-correlation properties better than a second threshold (e.g., a high threshold) may be selected, so that a sequence with low PAPR and good cross-correlation properties may be selected.

Under the proposed schemes, the different sequences may include one or more Constant Amplitude Zero Auto Correlation (CAZAC) sequences, one or more Zadoff-Chu sequences, one or more computer-generated sequences, or a combination thereof. Alternatively or additionally, the different sequences may be implemented by using a same sequence in different physical resource blocks (PRBs) or different sequences in different PRBs.

Under the proposed schemes, when the PUCCH is of a two-symbol PUCCH format, the selected sequence may be transmitted in the short PUCCH using frequency hopping or orthogonal cover code (OCC). Moreover, when transmitting through multiple antennas, the UE may transmit the selected sequence in the short PUCCH through multiple antennas using different cyclic shifts, different base sequences, different PRBs, or a combination thereof.

Under the proposed schemes in accordance with the present disclosure, a second format of the proposed one-symbol PUCCH formats is herein referred as frequency division multiplexing (FDM) of RS and UCI sequences. In this PUCCH format, both UCI and RS may be transmitted. Moreover, both UCI and RS may be transmitted in the same RB and multiplexed by FDM.

The US and UCI may use the same cyclic shift as follows:

$$d = ( \begin{matrix}exp ( - j 2 π α \frac{0}{{N}_{SC}^{RB} / 2} ) \\ exp ( - j 2 π α \frac{1}{{N}_{SC}^{RB} / 2} ) \\ ⋮ \\ exp ( - j 2 π α \frac{{N}_{SC}^{RB} / 2 - 1}{{N}_{SC}^{RB} / 2} )\end{matrix} )$$

Here, α may be a parameter of the cyclic shift.

With Y·εC^{N}^{_{SC}}^{^{RB}}/2 being a base sequence, the transmitting signal of RS and UCI may be expressed as follows:

x_{RS}=d ⊙Y·

x_{UCI}=(d ⊙Y·)s

Here, s may be a quadrature amplitude modulation (QAM) symbol modulated according to ACK/NACK bits. With FDM of RS and UCI sequences, x_{RS} and x_{UCI} may be transmitted in different subcarriers of the same RB using FDM.

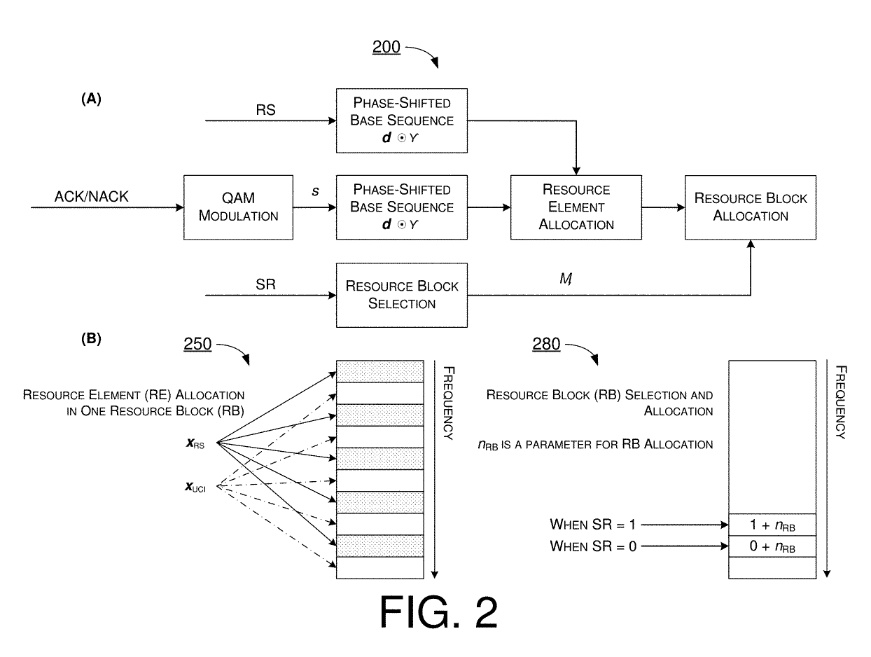

FIG. 2 illustrates an example design 200 as well as example scenario 250 and 280 in accordance with an implementation of the present disclosure. Part (A) of FIG. 2 shows example design 200, and part (B) of FIG. 2 shows example scenarios 250 and 280 of RB allocation and RB selection.

Referring to FIG. 2, in example design 200, information of ACK/NACK may be taken as input for QAM modulation to provide symbol s as an input to generate transmitting signal x_{UCI} via phase-shifted base sequence. Reference signal is also taken as input to generate transmitting signal x_{RS} via phase-shifted base sequence. Each of the signals x_{UCI} and x_{RS} may be allocated into multiple resource elements (RE) within each RB, as shown in example scenario 250. Then, scheduling requests may be used for RB selection to provide M,, which may be used for RB allocation, as shown in example scenario 280.

In the example shown in FIG. 2, SR is used to determine the RB set M,, and ACK/NACK is used to determine the symbol s. Moreover, the base sequence Y· is fixed, and cyclic shift α is fixed. Furthermore, it is noteworthy that SR and ACK may jointly be used to determine the following: RB set M,, symbol s, base sequence Y; and cyclic shift α.

For FDM of RS and UCI sequences, the RS may be generated using a first sequence and the UCI may be generated using a modulation of a second sequence (or a product of the second sequence multiplied by the modulation). The UCI may be in one of multiple UCI states. A sequence from multiple different sequences, each of which representative of a respective one of the multiple UCI states, may be selected. Alternatively, a modulation scheme from multiple different modulation schemes, each of which representative of a respective one of the plurality of UCI states, may be selected. Then, the selected sequence or the UCI with the selected modulation scheme may be transmitted, using FDM, in the short PUCCH with the RS.

Under the proposed schemes in accordance with the present disclosure, a third format of the proposed one-symbol PUCCH formats is herein referred as code division multiplexing (CDM) of RS and UCI sequences. In this PUCCH format, both UCI and RS may be transmitted. Moreover, both UCI and RS may be transmitted in the same RB and multiplexed by FDM.

The RS and UCI may respectively have different cyclic shifts as follows:

$${d}_{RS} = ( \begin{matrix}exp ( - j 2 π α \frac{0}{{N}_{SC}^{RB}} ) \\ exp ( - j 2 π α \frac{1}{{N}_{SC}^{RB}} ) \\ ⋮ \\ exp ( - j 2 π α \frac{{N}_{SC}^{RB} - 1}{{N}_{SC}^{RB}} )\end{matrix} )$$

$${d}_{UCI} = ( \begin{matrix}exp ( - j 2 π ( α + \frac{{N}_{SC}^{RB}}{2} ) \frac{0}{{N}_{SC}^{RB}} ) \\ exp ( - j 2 π ( α + \frac{{N}_{SC}^{RB}}{2} ) \frac{1}{{N}_{SC}^{RB}} ) \\ ⋮ \\ exp ( - j 2 π ( α + \frac{{N}_{SC}^{RB}}{2} ) \frac{{N}_{SC}^{RB} - 1}{{N}_{SC}^{RB}} )\end{matrix} )$$

With Y· being a base sequence, the transmitting signal of RS and UCI may be expressed as follows:

x_{RS}=d_{RS}⊙Y·

x_{UCI}=(d_{UCI}⊙Y·)s

Here, s may be a QAM symbol modulated according to ACK/NACK bits, and x_{RS} and x_{UCI} may be transmitted in the same RB using CDM.

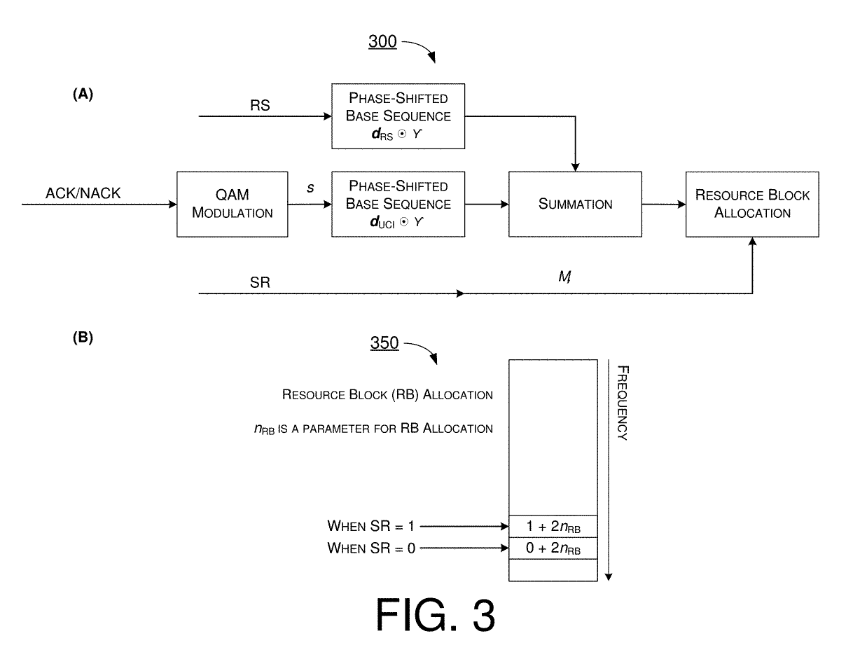

FIG. 3 illustrates an example design 300 and an example scenario 350 in accordance with an implementation of the present disclosure. Part (A) of FIG. 3 shows example design 300, and part (B) of FIG. 3 shows example scenario 350 of RB allocation.

Referring to FIG. 3, in example design 300, information of ACK/NACK may be taken as input for QAM modulation to provide symbol s as an input to generate transmitting signal x_{UCI} via phase-shifted base sequence. Reference signal is also taken as input to generate transmitting signal x_{RS} via phase-shifted base sequence. Both of the signals x_{UCI} and x_{RS} may be summed together by summation for RB allocation. Then, scheduling requests may be used for RB selection to provide M,, which may be used for RB allocation, as shown in example scenario 350.

Alternatively, PUCCH may also occupy multiple RBs. For simplicity, the following example is provided in the context of two RBs, although the concept may be allowed to implementations in which PUCCH occupies more than two RBs. As an example, with Y· being a base sequence, the transmitting signal of RS and UCI may involve a first transmitting signal in a first RB and a second transmitting signal in a second RB.

The first transmitting signal in the first RB may be expressed as follows:

$${x}_{RS} = {d}_{RS} ⊙ {Y}^{′}$$

$${x}_{data} = {e}^{j \frac{π}{4}} ( {d}_{data} ⊙ {Y}^{′} ) s$$

The second transmitting signal in the second RB may be expressed as follows:

$${x}_{RS} = - {d}_{RS} ⊙ {Y}^{′}$$

$${x}_{data} = {e}^{j \frac{π}{4}} ( {d}_{data} ⊙ {Y}^{′} ) s$$

For CDM of RS and UCI sequences, the RS may be generated using a first sequence and the UCI may be generated using a modulation of a second sequence (or a product of the second sequence multiplied by the modulation). The UCI may be in one of multiple UCI states. A sequence from multiple different sequences, each of which representative of a respective one of the multiple UCI states, may be selected. Alternatively, a modulation scheme from multiple different modulation schemes, each of which representative of a respective one of the plurality of UCI states, may be selected. Then, the selected sequence or the UCI with the selected modulation scheme may be transmitted, using CDM, in the short PUCCH with the RS.

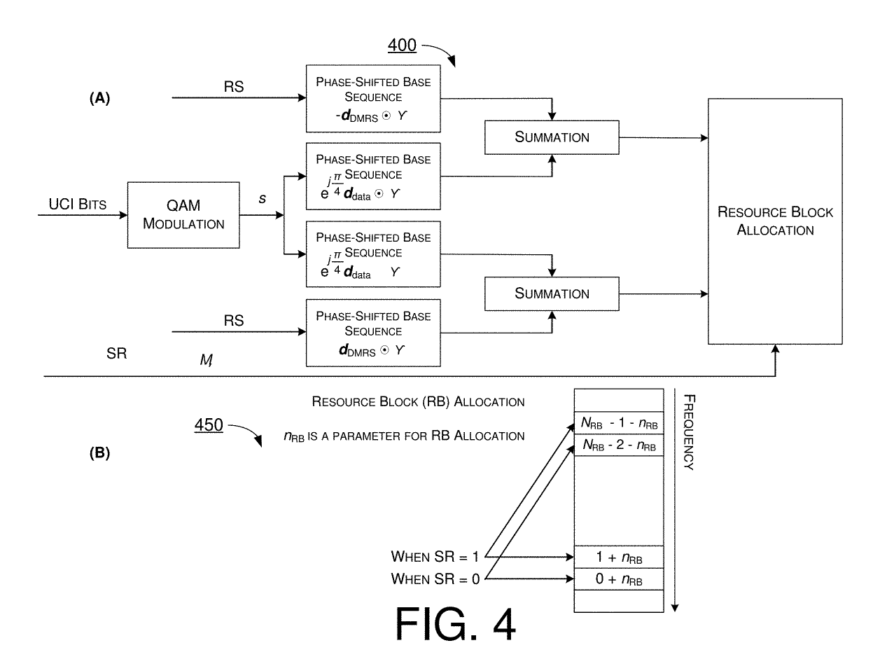

FIG. 4 illustrates an example design 400 and an example scenario 450 in accordance with an implementation of the present disclosure. Part (A) of FIG. 4 shows example design 400, and part (B) of FIG. 4 shows example scenario 450 of RB allocation.

Referring to FIG. 4, in example design 400, information of ACK/NACK may be taken as input for QAM modulation to provide symbol s as an input to generate transmitting signal)(data via phase-shifted base sequence. Reference signal is also taken as input to generate transmitting signal x_{RS} via phase-shifted base sequence. The first transmitting signal in the first RB may be generated by summing signals x_{UCI} and x_{RS} by summation for RB allocation. The second transmitting signal in the second RB may be generated by summing signals x_{UCI} and x_{RS} by summation for RB allocation. Then, scheduling requests may be used for RB selection to provide M,, which may be used for RB allocation for the first and second transmitting signals, as shown in example scenario 450.

In the example shown in FIG. 4, SR is used to determine the RB set M, and ACK/NACK is used to determine the symbol s. Moreover, the base sequence Y· is fixed, and cyclic shift sequences d_{RS} and d_{UCI} are fixed. Furthermore, it is noteworthy that SR and ACK may jointly be used to determine the following: RB set M,, symbol s, base sequence Y; and cyclic shift sequences d_{RS} and d_{UCI}.

PUCCH Format with Multiple Transmitting Antennas

Under the proposed schemes in accordance with the present disclosure, PUCCH with multiple transmitting antennas may be designed in a way that two criteria are satisfied. The first criterion is that the procedure for PUCCH with multiple transmitting antennas is similar with that for PUCCH with one transmitting antenna. The second criterion is that the signal at different antennas is generated using different values of base sequence Y; cyclic shift α, and RB set M,.

With respect to sequence selection without RS (one-symbol PUCCH format), for each transmitting antenna t=0, 1, . . . N_{T}−1, the UCI may determine the following information: base sequence Y·ₜ, cyclic shift αₜ, and RB index(es) M,ₜ in which the PUCCH is transmitted.

Under the proposed schemes, a cyclic shift sequence dₜ may be generated according to αₜ. The transmitting signal of antenna t may be expressed as follows:

xₜ=Y·ₜ⊙dₜ

$${Y}_{t}^{′} ∈ {ℂ}^{{N}_{SC}^{RB}}$$

Here, is a base sequence, and ⊙ means elementwise product. The transmitting signal xₜ may be put in all RBs in RB set M,ₜ.

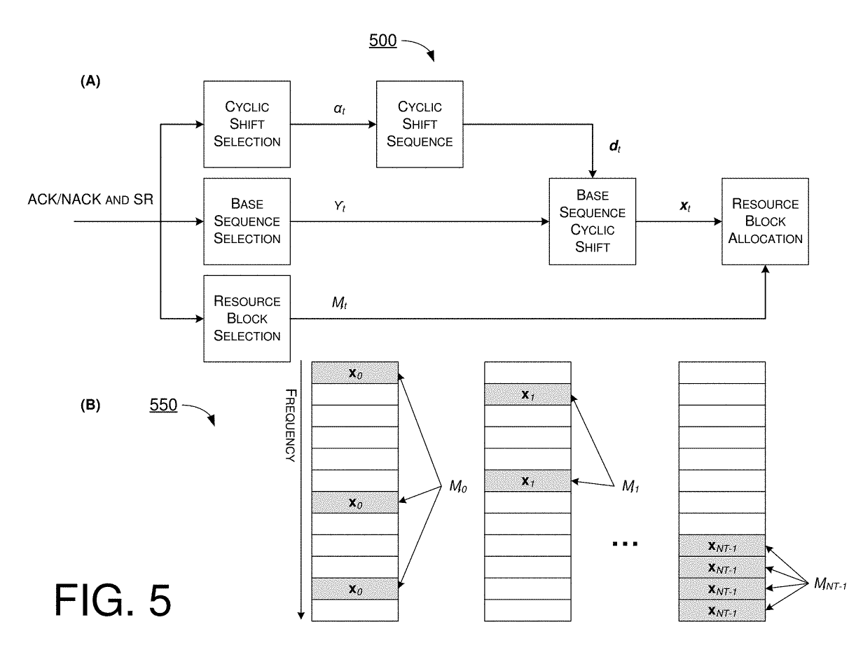

FIG. 5 illustrates an example design 500 and an example scenario 550 in accordance with an implementation of the present disclosure. Part (A) of FIG. 5 shows example design 500, and part (B) of FIG. 5 shows example scenario 550 of how the transmitting signal xₜ may be put in all RBs in a RB set M,ₜ.

Referring to FIG. 5, in example design 500, information of ACK/NACK and SR may be taken as input for cyclic shift selection (to provide αₜ), base sequence selectin (to provide Y·ₜ) and RB selection (to provide M,ₜ). Using at and Y·ₜ, as inputs for base sequence cyclic shift, the output may be the transmitting signal xₜ. The transmitting signal xₜ may then be put in RB set M,ₜ with RB allocation as shown in example scenario 550.

### Two-Symbol PUCCH Format

Under the proposed schemes in accordance with the present disclosure, a two-symbol PUCCH may be designed using schemes and concepts described above with respect to one-symbol PUCCH, along with either of orthogonal cover code (OCC) and frequency hopping. With OCC, a user equipment (UE) may be assigned with an OCC to generate the two-symbol PUCCH signal in first and second OFDM symbols. With frequency hopping, the UE may transmit the two-symbol PUCCH in one or more RBs in a first OFDM symbol and in one or more other RBs in a second OFDM symbol.

With respect to sequence selection without RS and using OCC, the UCI may determine the sequence to transmit without transmitting RS. Moreover, the UCI may determine the following information: base sequence Y·, cyclic shift α, and RB index(es) M, in which the PUCCH is transmitted. Additionally, the UE may be assigned an OCC (ω₀ or ω₁) by the base station (e.g., eNB, gNB or TRP), as follows:

ω₀^{T}=[+1 +1],ω₁^{T}=[+1 −1]

Under the proposed schemes, a cyclic shift sequence may be generated according to α as follows:

$$d = {[ \begin{matrix}exp ( - j 2 π α \frac{0}{{N}_{SC}^{RB}} ) & exp ( - j 2 π α \frac{1}{{N}_{SC}^{RB}} ) & … & exp ( - j 2 π α \frac{{N}_{SC}^{RB} - 1}{{N}_{SC}^{RB}} )\end{matrix} ]}^{T}$$

Here, N_{SC}^{RB} is the number of subcarriers in a RB. The transmitting signal in a RB and one OFDM symbol may be expressed as follows:

x=Y·⊙d

Here, Y·εC^{N}^{_{SC}}^{^{RB}} is a base sequence, and ⊙ means elementwise product.

Moreover, OCC may be used to generate transmitting signal in a RB and two OFDM symbols expressed as follows:

xωₙ

Here, ωₙ is the OCC assigned by the base station. The transmitting signal x may be put in all RBs in RB set M,.

With respect to sequence selection without RS and using frequency hopping, frequency hopping may differ from OCC in at least two ways. Firstly, there may be no OCC assigned in frequency hopping. Secondly, in frequency hopping, the UCI may determine RB set M,₀ for symbol 0 and M,₁ for symbol 1.

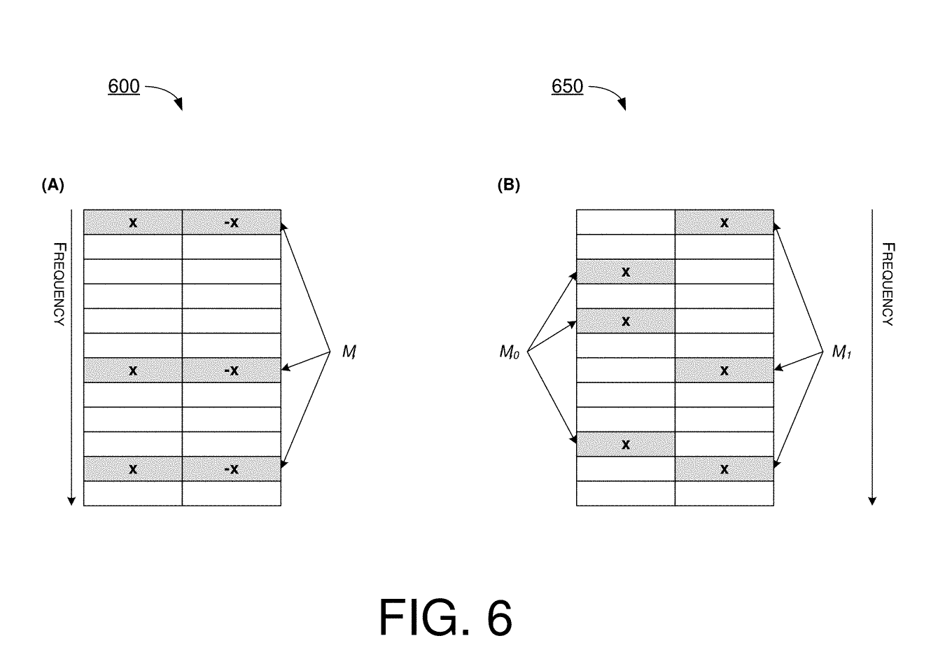

FIG. 6 illustrates example scenario 600 and example scenario 650 in accordance with an implementation of the present disclosure. Part (A) of FIG. 6 shows example scenario 600 of allocating two OFDM symbols to RB set M. Part (B) of FIG. 6 shows example scenario 650 of sequence selection using frequency hopping.

### Illustrative Implementation

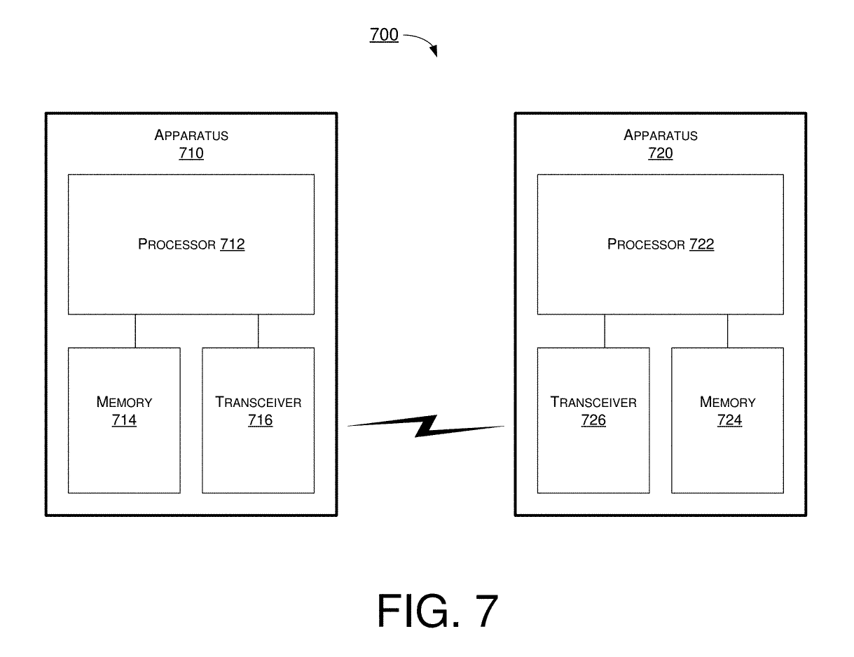

FIG. 7 illustrates an example system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to short PUCCH in NR networks, including the various schemes, concepts and examples described above with respect to FIG. 1-FIG. 6 described above as well as processes 800, 900 and 1000 described below.

Each of apparatus 710 and apparatus 720 may be a part of an electronic apparatus, which may be a base station (BS) or a user equipment (UE), such as a portable or mobile apparatus, a wearable apparatus, a wireless communication apparatus or a computing apparatus. For instance, each of apparatus 710 and apparatus 720 may be implemented in a smartphone, a smartwatch, a personal digital assistant, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a wire communication apparatus or a computing apparatus. For instance, each of apparatus 710 and apparatus 720 may be implemented in a smart thermostat, a smart fridge, a smart door lock, a wireless speaker or a home control center. When implemented in or as a BS, apparatus 710 and/or apparatus 720 may be implemented in an eNodeB in a LTE, LTE-Advanced or LTE-Advanced Pro network or in a gNB or transmit-and-receive point (TRP) in a 5G network, an NR network or an IoT network.

In some implementations, each of apparatus 710 and apparatus 720 may be implemented in the form of one or more integrated-circuit (IC) chips such as, for example and without limitation, one or more single-core processors, one or more multi-core processors, or one or more complex-instruction-set-computing (CISC) processors. In the various schemes described above with respect to FIG. 1-FIG. 6, each of apparatus 710 and apparatus 720 may be implemented in or as a BS or a UE. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including those pertaining to short PUCCH in NR networks in accordance with various implementations of the present disclosure.

In some implementations, apparatus 710 may also include a transceiver 716 coupled to processor 712. Transceiver 716 may be capable of wirelessly transmitting and receiving data, information and/or signals. In some implementations, apparatus 720 may also include a transceiver 726 coupled to processor 722. Transceiver 726 may include a transceiver capable of wirelessly transmitting and receiving data, information and/or signals.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

In the interest of brevity and to avoid redundancy, detailed description of functions, capabilities and operations of apparatus 710 and apparatus 720 is provided below with respect to processes 800, 900 and 1000.

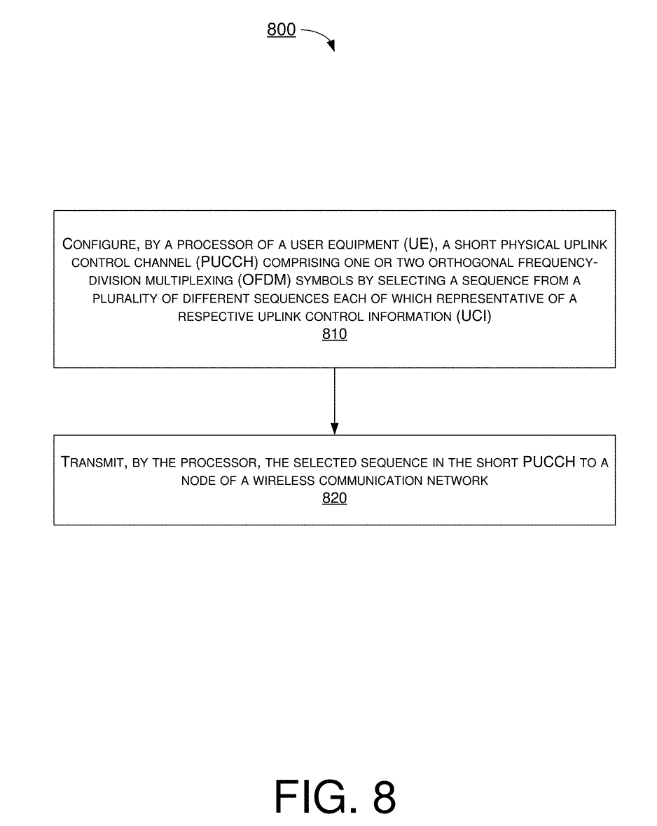

FIG. 8 illustrates an example process 800 in accordance with an implementation of the present disclosure. Process 800 may represent an aspect of implementing the proposed concepts and schemes such as one or more of the various schemes, concepts and examples described above with respect to FIG. 1-FIG. 7. More specifically, process 800 may represent an aspect of the proposed concepts and schemes pertaining to short PUCCH in NR networks. For instance, process 800 may be an example implementation, whether partially or completely, of the proposed schemes, concepts and examples described above for short PUCCH in NR networks. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. The blocks/sub-blocks of process 800 may be executed iteratively. Process 800 may be implemented by or in apparatus 710 and/or apparatus 720 as well as any variations thereof. Solely for illustrative purposes and without limiting the scope, process 800 is described below in the context of apparatus 710 being a UE and apparatus 720 being a network node of a wireless communication network (e.g., an NR network). Process 800 may begin at block 810.

At 810, process 800 may involve processor 712 of apparatus 710 as a UE configuring a short PUCCH comprising one or two OFDM symbols (e.g., the short PUCCH is of either the one-symbol format or the two-symbol format as described above). In configuration the short PUCCH, process 800 may involve processor 712 selecting a sequence from a plurality of different sequences each of which representative of a respective UCI. Process 800 may proceed from 810 to 820.

At 820, process 800 may involve processor 712 transmitting, via transceiver 716, the selected sequence in the short PUCCH to apparatus 720. In some implementations, the selected sequence in the short PUCCH may be transmitted to apparatus 720, as a network node of a wireless communication network, without a reference signal (RS).

In some implementations, in selecting the sequence from the different sequences, process 800 may involve processor 712 generating a base sequence. Additionally, process 800 may involve processor 712 performing a respective cyclic shift on the base sequence to generate each sequence of the different sequences such that different cyclic shifts are used to generate the different sequences.

In some implementations, in selecting the sequence from the different sequences, process 800 may involve processor 712 generating multiple base sequences. Moreover, process 800 may involve processor 712 performing a same cyclic shift on each of the multiple base sequences to generate a respective sequence of the different sequences.

In some implementations, the different sequences may include a same sequence in different physical resource blocks (PRBs) or different sequences in different PRBs.

In some implementations, a respective PAPR of each sequence of the plurality of different sequences may be lower than a first threshold (e.g., a low threshold) or one or more cross-correlation properties of each sequence of the plurality of different sequences are better than a second threshold (e.g., a high threshold), so that a sequence with low PAPR and good cross-correlation properties may be selected or otherwise used. Moreover, the plurality of different sequences may include one or more CAZAC sequences, one or more Zadoff-Chu sequences, one or more computer-generated sequences, or a combination thereof.

In some implementations, the PUCCH may include two OFDM symbols. In such cases, in transmitting the selected sequence in the short PUCCH, process 800 may involve processor 712 transmitting the selected sequence in the short PUCCH using frequency hopping or orthogonal cover code (OCC).

In some implementations, in transmitting the selected sequence in the short PUCCH, process 800 may involve processor 712 transmitting the selected sequence in the short PUCCH through multiple antennas using different cyclic shifts, different base sequences, different PRBs, or a combination thereof.

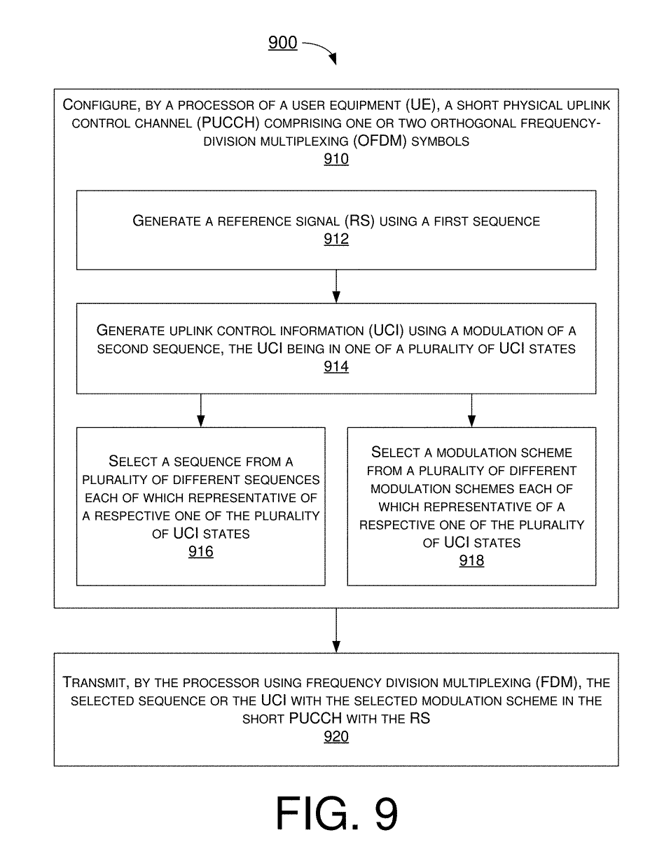

FIG. 9 illustrates an example process 900 in accordance with an implementation of the present disclosure. Process 900 may represent an aspect of implementing the proposed concepts and schemes such as one or more of the various schemes, concepts and examples described above with respect to FIG. 1-FIG. 7. More specifically, process 900 may represent an aspect of the proposed concepts and schemes pertaining to short PUCCH in NR networks. For instance, process 900 may be an example implementation, whether partially or completely, of the proposed schemes, concepts and examples described above for short PUCCH in NR networks. Process 900 may include one or more operations, actions, or functions as illustrated by one or more of blocks 910 and 920 as well as sub-blocks 912 and 914. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively in a different order. The blocks/sub-blocks of process 900 may be executed iteratively. Process 900 may be implemented by or in apparatus 710 and/or apparatus 720 as well as any variations thereof. Solely for illustrative purposes and without limiting the scope, process 900 is described below in the context of apparatus 710 being a UE and apparatus 720 being a network node of a wireless communication network (e.g., an NR network). Process 900 may begin at block 910.

At 910, process 900 may involve processor 712 of apparatus 710 as a UE configuring a short PUCCH comprising one or two OFDM symbols (e.g., the short PUCCH is of either the one-symbol format or the two-symbol format as described above). In configuration the short PUCCH, process 900 may involve processor 712 performing a number of operations represented by sub-blocks 912, 914 and 916 (or 918) to be described below. Process 900 may proceed from 910 to 920.

At 920, process 900 may involve processor 712 transmitting, via transceiver 716 using frequency division multiplexing (FDM), the selected sequence or the UCI with the selected modulation scheme in the short PUCCH with a RS.

At 912, process 900 may involve processor 712 generating the UR using a first sequence. Process 900 may proceed from 912 to 914.

At 914, process 900 may involve processor 712 generating UCI using a modulation of a second sequence (or a product of the second sequence multiplied by the modulation). The UCI may be in one of multiple UCI states. Process 900 may proceed from 914 to either 916 or 918.

At 916, process 900 may involve processor 712 selecting a sequence from a number of different sequences each of which representative of a respective one of the multiple UCI states.

At 918, process 900 may involve processor 712 selecting a modulation scheme from a number of different modulation schemes each of which representative of a respective one of the multiple UCI states.

In some implementations, in selecting the sequence from the different sequences, process 900 may involve processor 712 generating a base sequence. Additionally, process 900 may involve processor 712 performing a respective cyclic shift on the base sequence to generate each sequence of the different sequences such that different cyclic shifts are used to generate the different sequences.

In some implementations, in selecting the sequence from the different sequences, process 900 may involve processor 712 generating multiple base sequences. Moreover, process 900 may involve processor 712 performing a same cyclic shift on each of the multiple base sequences to generate a respective sequence of the different sequences.

In some implementations, the different sequences may include a same sequence in different PRBs or different sequences in different PRBs.

In some implementations, a respective PAPR of each sequence of the plurality of different sequences may be lower than a first threshold (e.g., a low threshold) or one or more cross-correlation properties of each sequence of the plurality of different sequences are better than a second threshold (e.g., a high threshold), so that a sequence with low PAPR and good cross-correlation properties may be selected or otherwise used. Moreover, the plurality of different sequences may include one or more CAZAC sequences, one or more Zadoff-Chu sequences, one or more computer-generated sequences, or a combination thereof.

In some implementations, the PUCCH may include two OFDM symbols. In such cases, in transmitting the selected sequence in the short PUCCH, process 900 may involve processor 712 transmitting the selected sequence in the short PUCCH using frequency hopping or OCC.

In some implementations, in transmitting the selected sequence in the short PUCCH, process 900 may involve processor 712 transmitting the selected sequence in the short PUCCH through multiple antennas using different cyclic shifts, different base sequences, different PRBs, or a combination thereof.

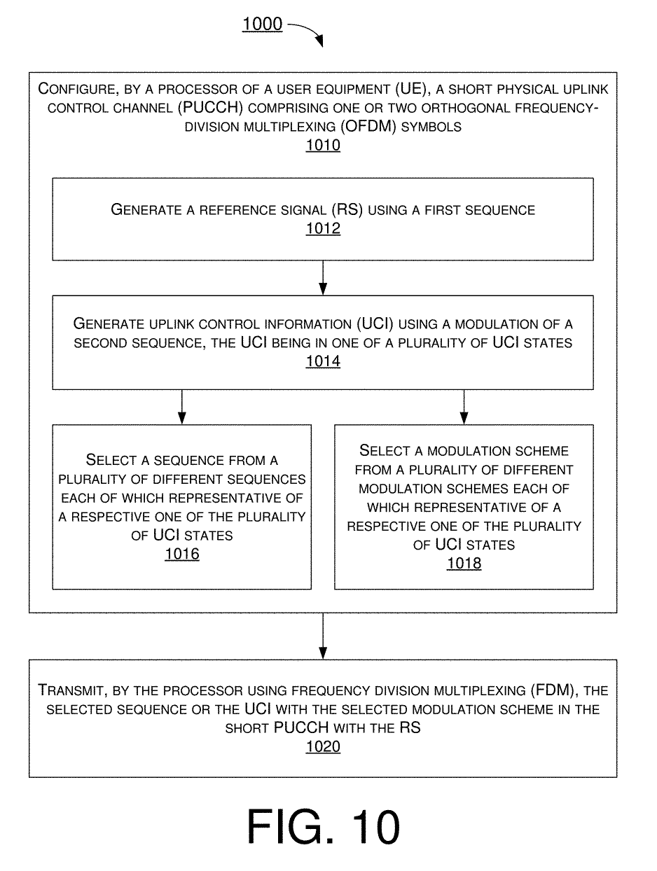

FIG. 10 illustrates an example process 1000 in accordance with an implementation of the present disclosure. Process 1000 may represent an aspect of implementing the proposed concepts and schemes such as one or more of the various schemes, concepts and examples described above with respect to FIG. 1-FIG. 7. More specifically, process 1000 may represent an aspect of the proposed concepts and schemes pertaining to short PUCCH in NR networks. For instance, process 1000 may be an example implementation, whether partially or completely, of the proposed schemes, concepts and examples described above for short PUCCH in NR networks. Process 1000 may include one or more operations, actions, or functions as illustrated by one or more of blocks 1010 and 1020 as well as sub-blocks 1012 and 1014. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively in a different order. The blocks/sub-blocks of process 1000 may be executed iteratively. Process 1000 may be implemented by or in apparatus 710 and/or apparatus 720 as well as any variations thereof. Solely for illustrative purposes and without limiting the scope, process 1000 is described below in the context of apparatus 710 being a UE and apparatus 720 being a network node of a wireless communication network (e.g., an NR network). Process 1000 may begin at block 1010.

At 1010, process 1000 may involve processor 712 of apparatus 710 as a UE configuring a short PUCCH comprising one or two OFDM symbols (e.g., the short PUCCH is of either the one-symbol format or the two-symbol format as described above). In configuration the short PUCCH, process 1000 may involve processor 712 performing a number of operations represented by sub-blocks 1012, 1014 and 1016 (or 1018) to be described below. Process 1000 may proceed from 1010 to 1020.

At 1020, process 1000 may involve processor 712 transmitting, via transceiver 716 using code division multiplexing (CDM), the selected sequence or the UCI with the selected modulation scheme in the short PUCCH with a RS.

At 1012, process 1000 may involve processor 712 generating the UR using a first sequence. Process 1000 may proceed from 1012 to 1014.

At 1014, process 1000 may involve processor 712 generating UCI using a modulation of a second sequence (or a product of the second sequence multiplied by the modulation). The UCI may be in one of multiple UCI states. Process 1000 may proceed from 1014 to either 1016 or 1018.

At 1016, process 1000 may involve processor 712 selecting a sequence from a number of different sequences each of which representative of a respective one of the multiple UCI states.

At 1018, process 1000 may involve processor 712 selecting a modulation scheme from a number of different modulation schemes each of which representative of a respective one of the multiple UCI states.

In some implementations, in selecting the sequence from the different sequences, process 1000 may involve processor 712 generating a base sequence. Additionally, process 1000 may involve processor 712 performing a respective cyclic shift on the base sequence to generate each sequence of the different sequences such that different cyclic shifts are used to generate the different sequences.

In some implementations, in selecting the sequence from the different sequences, process 1000 may involve processor 712 generating multiple base sequences. Moreover, process 1000 may involve processor 712 performing a same cyclic shift on each of the multiple base sequences to generate a respective sequence of the different sequences.

In some implementations, the different sequences may include a same sequence in different PRBs or different sequences in different PRBs.

In some implementations, a respective PAPR of each sequence of the plurality of different sequences may be lower than a first threshold (e.g., a low threshold) or one or more cross-correlation properties of each sequence of the plurality of different sequences are better than a second threshold (e.g., a high threshold), so that a sequence with low PAPR and good cross-correlation properties may be selected or otherwise used. Moreover, the plurality of different sequences may include one or more CAZAC sequences, one or more Zadoff-Chu sequences, one or more computer-generated sequences, or a combination thereof.

In some implementations, the PUCCH may include two OFDM symbols. In such cases, in transmitting the selected sequence in the short PUCCH, process 1000 may involve processor 712 transmitting the selected sequence in the short PUCCH using frequency hopping or OCC.

In some implementations, in transmitting the selected sequence in the short PUCCH, process 1000 may involve processor 712 transmitting the selected sequence in the short PUCCH through multiple antennas using different cyclic shifts, different base sequences, different PRBs, or a combination thereof.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
configuring, by a processor of a user equipment (UE), a short physical uplink control channel (PUCCH) comprising one or two orthogonal frequency-division multiplexing (OFDM) symbols, the configuring comprising selecting a sequence from a plurality of different sequences each of which representative of a respective uplink control information (UCI); and
transmitting, by the processor, the selected sequence in the short PUCCH to a node of a wireless communication network.

2. The method of claim 1, wherein the selecting of the sequence from the plurality of different sequences comprises:
generating a base sequence; and
performing a respective cyclic shift on the base sequence to generate each sequence of the plurality of different sequences such that different cyclic shifts are used to generate the plurality of different sequences.

3. The method of claim 1, wherein the selecting of the sequence from the plurality of different sequences comprises:
generating a plurality of base sequences; and
performing a same cyclic shift on each of the plurality of base sequences to generate a respective sequence of the plurality of different sequences.

4. The method of claim 1, wherein the plurality of different sequences comprise a same sequence in different physical resource blocks (PRBs) or different sequences in different PRBs.

5. The method of claim 1, wherein a respective peak-to-average-power-ratio (PAPR) of each sequence of the plurality of different sequences is lower than a first threshold or one or more cross-correlation properties of each sequence of the plurality of different sequences are better than a second threshold, and wherein the plurality of different sequences comprise one or more Constant Amplitude Zero Auto Correlation (CAZAC) sequences, one or more Zadoff-Chu sequences, one or more computer-generated sequences, or a combination thereof.

6. The method of claim 1, wherein the PUCCH comprises two OFDM symbols, and wherein the transmitting of the selected sequence in the short PUCCH comprises transmitting the selected sequence in the short PUCCH using frequency hopping or orthogonal cover code (OCC).

7. The method of claim 1, wherein the transmitting of the selected sequence in the short PUCCH comprises transmitting the selected sequence in the short PUCCH through multiple antennas using different cyclic shifts, different base sequences, different physical resource blocks (PRBs), or a combination thereof.

8. A method, comprising:
configuring, by a processor of a user equipment (UE), a short physical uplink control channel (PUCCH) comprising one or two orthogonal frequency-division multiplexing (OFDM) symbols, the configuring comprising:
generating a reference signal (RS) using a first sequence;
generating uplink control information (UCI) using a modulation of a second sequence, the UCI being in one of a plurality of UCI states; and
performing either of:
selecting a sequence from a plurality of different sequences each of which representative of a respective one of the plurality of UCI states; or
selecting a modulation scheme from a plurality of different modulation schemes each of which representative of a respective one of the plurality of UCI states; and
transmitting, by the processor using frequency division multiplexing (FDM), the selected sequence or the UCI with the selected modulation scheme in the short PUCCH with the RS.

9. The method of claim 8, wherein the selecting of the sequence from the plurality of different sequences comprises:
generating a base sequence; and
performing a respective cyclic shift on the base sequence to generate each sequence of the plurality of different sequences such that different cyclic shifts are used to generate the plurality of different sequences.

10. The method of claim 8, wherein the selecting of the sequence from the plurality of different sequences comprises:
generating a plurality of base sequences; and
performing a same cyclic shift on each of the plurality of base sequences to generate a respective sequence of the plurality of different sequences.

11. The method of claim 8, wherein the plurality of different sequences comprise a same sequence in different physical resource blocks (PRBs) or different sequences in different PRBs.

12. The method of claim 8, wherein a respective peak-to-average-power-ratio (PAPR) of each sequence of the plurality of different sequences is lower than a first threshold or one or more cross-correlation properties of each sequence of the plurality of different sequences are better than a second threshold, and wherein the plurality of different sequences comprise one or more Constant Amplitude Zero Auto Correlation (CAZAC) sequences, one or more Zadoff-Chu sequences, one or more computer-generated sequences, or a combination thereof.

13. The method of claim 8, wherein the PUCCH comprises two OFDM symbols, and wherein the transmitting of the selected sequence or the UCI with the selected modulation scheme in the short PUCCH comprises transmitting the selected sequence or the UCI with the selected modulation scheme in the short PUCCH using frequency hopping or orthogonal cover code (OCC).

14. The method of claim 8, wherein the transmitting of the selected sequence or the UCI with the selected modulation scheme in the short PUCCH comprises transmitting the selected sequence or the UCI with the selected modulation scheme in the short PUCCH through multiple antennas using different cyclic shifts, different base sequences, different physical resource blocks (PRBs), or a combination thereof.

15. A method, comprising:
configuring, by a processor of a user equipment (UE), a short physical uplink control channel (PUCCH) comprising one or two orthogonal frequency-division multiplexing (OFDM) symbols, the configuring comprising:
generating a reference signal (RS) using a first sequence;
generating uplink control information (UCI) using a modulation of a second sequence, the UCI being in one of a plurality of UCI states; and
performing either of:
selecting a sequence from a plurality of different sequences each of which representative of a respective one of the plurality of UCI states; or
selecting a modulation scheme from a plurality of different modulation schemes each of which representative of a respective one of the plurality of UCI states; and
transmitting, by the processor using code division multiplexing (CDM), the selected sequence or the UCI with the selected modulation scheme in the short PUCCH with the RS.

16. The method of claim 15, wherein the selecting of the sequence from the plurality of different sequences comprises:
generating a base sequence; and
performing a respective cyclic shift on the base sequence to generate each sequence of the plurality of different sequences such that different cyclic shifts are used to generate the plurality of different sequences.

17. The method of claim 15, wherein the selecting of the sequence from the plurality of different sequences comprises:
generating a plurality of base sequences; and
performing a same cyclic shift on each of the plurality of base sequences to generate a respective sequence of the plurality of different sequences.

18. The method of claim 15, wherein the plurality of different sequences comprise a same sequence in different physical resource blocks (PRBs) or different sequences in different PRBs.

19. The method of claim 15, wherein the PUCCH comprises two OFDM symbols, and wherein the transmitting of the selected sequence or the UCI with the selected modulation scheme in the short PUCCH comprises transmitting the selected sequence or the UCI with the selected modulation scheme in the short PUCCH using frequency hopping or orthogonal cover code (OCC).

20. The method of claim 15, wherein the transmitting of the selected sequence or the UCI with the selected modulation scheme in the short PUCCH comprises transmitting the selected sequence or the UCI with the selected modulation scheme in the short PUCCH through multiple antennas using different cyclic shifts, different base sequences, different physical resource blocks (PRBs), or a combination thereof.
